(19) United States
(12) Patent Application Publication
(10) Pub. No.: US 2008/0019480 A1
(43) Pub. Date: Jan. 24, 2008

(54) METHOD AND APPARATUS FOR CONTROLLING X-RAY MACHINE TO IRRADIATE A NARROWED PORTION

(76) Inventors: Kuei-Wen Cheng, Guanyin Township (TW); Jeng-Ywan Jeng, Guanyin Township (TW); Te-Fong Chan, Guanyin Township (TW)

Correspondence Address: HDSL, 4331 STEVENS BATTLE LANE, FAIRFAX, VA, 22033, US

(21) Appl. No.: 11/751,908

(22) Filed: May 22, 2007

Related U.S. Application Data
(63) Continuation-in-part of application No. 11/459,512, filed on Jul. 24, 2006, now abandoned.

(51) Int. Cl. H05G 1/64

(52) U.S. Cl. 378/98.12

(57) ABSTRACT

An X-ray machine being able to irradiate a narrowed portion within a maximum irradiation range through a control to the electrodes of an X-ray generator is provided. The X-ray machine includes a controllable X-ray generator, a digital camera and a control unit. The digital camera produces a digital visible-light image the same as the maximum irradiation range of the X-ray generator. A narrowed image portion within the digital image can be selected by the control unit. The control unit generates control signals corresponding to the selected image portion. The X-ray generator emits X-rays onto an object portion corresponding to the selected image portion based on the control signals.

This application is a continuation-in-part of U.S. patent application Ser. No. 11/459,512 filed Jul. 24, 2006.

### BACKGROUND OF THE INVENTION

1. Technical Field

The present invention relates to an X-ray machine, and more particularly to an X-ray machine with narrowing irradiation.

2. Description of Prior Art

X-rays are a form of ionizing radiation. An X-ray machine emits radioactive rays to produce an image of an object for visualizing something located under the surface of the object, and thus X-rays are primarily used for diagnostic radiography and crystallography. Nowadays, X-ray machines have become one of the most indispensable medical instruments. X-ray machines are often used for irradiating a specific portion of a patient for detecting fracture, cancers or inserted foreign matters in human bodies. Unlike visible lights, X-rays are radioactive and hazardous to human. Therefore, the range of the patient that is irradiated by the X-ray should be minimized according to individual medical requirements.

In addition to the medical applications, X-ray machines are also used extensively in the field of industrial inspection such as the detection of a defectively packaged assembly or a poorly soldered circuit board. For example, X-rays are also used in the inspection of electronic apparatuses, and may damage the electric components of the electronic apparatuses. To prevent unnecessary damages of electric components, the irradiating range of an X-raying inspection should be minimized.

However, the conventional X-ray machine can only be used for providing a predetermined and fixed irradiating range and can not be adjusted according to actual situations to narrow down. Therefore the patients who or the apparatuses which accept X-raying inspection usually are irradiated overbroadly.

### SUMMARY OF THE INVENTION

The objective of the present invention is to provide an X-ray machine and a method for irradiating X-ray to a selectably narrowed portion within a maximum irradiation range.

To achieve the foregoing objective, the present invention provides a controllable X-ray machine comprising a controllable X-ray generator, a digital camera and a control unit. The control unit electrically connects the controllable X-ray generator and the digital camera. The controllable X-ray generator can be controlled to adjustably irradiate a narrowed object portion within a maximum irradiation range thereof. The digital camera is arranged correspondingly to the controllable X-ray generator to shoot a digital visible-light image which is the same as what the maximum irradiation range of the controllable X-ray generator covers. The control unit can be configured to select a narrowed image portion within the digital visible-light image sent from the digital camera and generates control signals corresponding to the selected image portion. The control unit sends the control signals to the controllable X-ray generator to drive the controllable X-ray generator to irradiate the selected object portion which is corresponding to the selected image portion and narrower than the maximum irradiation range.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a block diagram of a controllable X-ray machine for irradiating a narrowed portion according to the present invention.

FIG. 2 shows an explanatory diagrams illustrating a narrowed irradiation of an X-ray generator.

FIGS. 3A and 3B show a relationship between a digital visible-light image and an X-ray image.

FIG. 4 shows a flowchart of a method for controlling an X-ray generator to irradiate a narrowed portion.

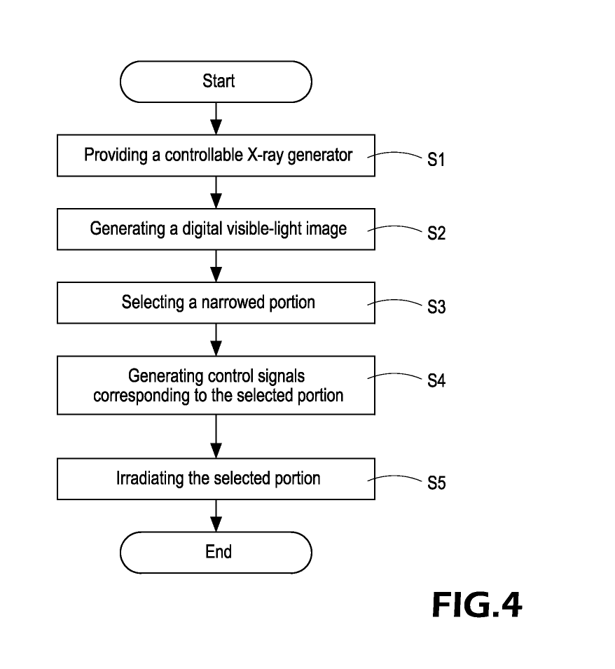

### DETAILED DESCRIPTION OF THE INVENTION

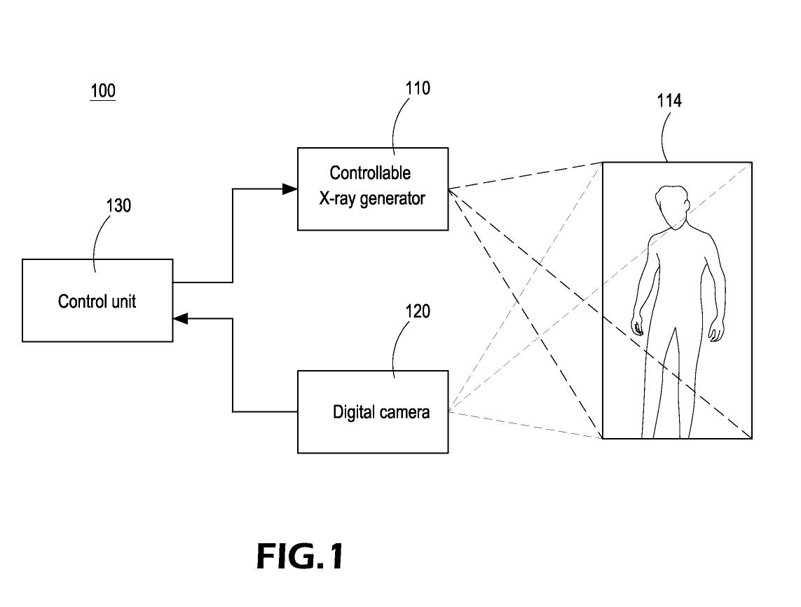

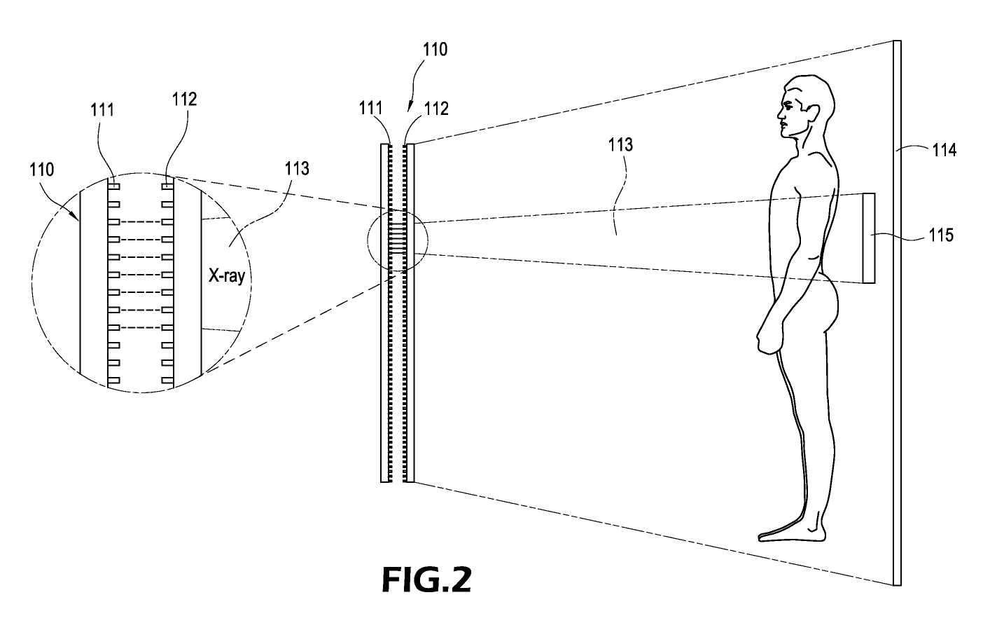

FIG. 1 shows a block diagram of the controllable X-ray machine 100 for irradiating a narrowed portion according to the present invention. The controllable X-ray machine 100 includes a controllable X-ray generator 110, a digital camera 120 and a control unit 130. The X-ray generator 110 and the digital camera 120 are electrically connected to the control unit 130. The X-ray generator 110 is a cold cathode field emission device essentially including a plurality of coupling anodes and cathodes. As shown in FIG. 2, each cathode 111 aligns a corresponding anode 112 and can be controlled individually. Each of the cathodes 111 individually emits e-beams to the corresponding anode 112 when an electric field is applied between a couple of a specific anode 112 and cathode 111. Then the anodes 112 which are collided by the e-beams from the cathodes 111 will emit X-rays 113 outward. A maximum irradiation range 114 of the X-ray generator 110 will exist while all of the anodes 112 are emitting X-rays. Further, the irradiation range can be adjusted to a narrowed object portion 115 within the maximum irradiation range 114 by controlling the anodes 112 and/or cathodes 111.

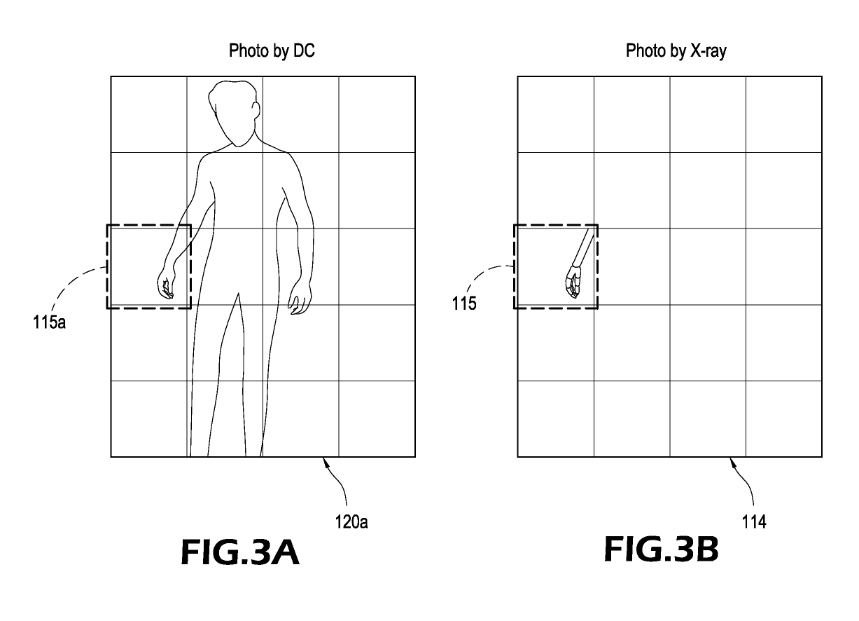

Referring to FIG. 3, the digital camera 120 has a specific position relationship with the X-ray generator 110 such that the image-shooting area of the digital camera 120 is unvaryingly the same as the maximum irradiation range 114 of the X-ray generator 110. When the controllable X-ray machine 100 is used, the digital camera 120 first takes a digital visible-light image 120a for the object to be irradiated. The digital visible-light image 120a will be substantially the same as what the maximum irradiation range 114 covers. The digital visible-light image 120a is sent to the control unit 130. When the control unit 130 receives the digital visible-light image 120a, the control unit 130 can be configured to select a narrowed image portion 115a within the digital visible-light image 120a automatically or manually. The control unit 130 then generates control signals corresponding to the selected image portion 115a and sends the control signals including position data related to the selected image portion 115a to the X-ray generator 110. Afterward, the cathodes 111 and/or the anodes 112 of the X-ray generator 110 are controlled by the control signals to drive the X-ray generator 110 to irradiate the selected object portion 115 within the maximum irradiation range 114. The selected object portion 115 is corresponding to the selected image portion 115a. As shown in FIG. 2, the actual X-ray emitting range on the X-ray generator 110 will be narrower than the selected object portion 115 within the maximum irradiation range 114 due to fan-shaped radiation of X-rays. The control unit 130 can calculate a required emitting range on the X-ray generator 110 according to the distance between the X-ray generator 110 and the object, and the sectorial angle of X-ray radiation.

As mentionedabove, the operation of selecting a narrowed image portion 115a within the digital visible-light image 120a by the control unit 130 is automatically or manually. In the manual operation mode, a user can preview the digital visible-light image 120a shot by the digital camera 120 and selects a narrowed image portion 115a within the digital visible-light image 120a, then the narrowed object portion 115 corresponding to the selected image portion 115a will be irradiated by X-rays emitted from the X-ray generator 110. The control unit 130 will generate corresponding control signals according to the relative position between the selected image portion 115a and the digital image 120a. The X-ray generator 110 emits X-ray only to irradiate the selected portion 115 after receiving the control signals and under the control thereof. Therefore a narrowed X-ray image as shown in FIG. 3B can be produced. In the automatic operation mode, a user can set the control unit 130 to automatically detect a specific portion of the object in the digital visible-light image 120a such as a face or breast. The X-ray generator 110 will be automatically controlled to irradiate the detected portion.

Moreover, the present invention also provides a method for controlling an X-ray machine to irradiate a narrowed object portion. The method comprises following steps:

A controllable X-ray generator 110 is first provided in step S1. As mentionedabove, the controllable X-ray generator 110 is a cold cathode field emission device comprising a plurality of coupling anodes 112 and cathodes 111, and each of the cathodes 111 and anodes 112 can be controlled individually, and a maximum irradiation range 114 exists when all of the anodes 112 emit X-rays;

A digital visible-light image 120a is then generated in step S2, wherein the shooting area of the digital visible-light image 120a is the same as the maximum irradiation range 114 of the controllable X-ray generator 110.

After the digital visible-light image 120a is generated, a specific narrowed image portion 115a within the digital visible-light image 120a is selected in step S3 and control signals corresponding to the selected image portion 115a is generated in step S4.

Finally, the controllable X-ray generator 110 emits X-rays to a selected object portion 115 within the maximum irradiation range 114. The selected objected portion 115 is corresponding to the selected image portion 115a within the digital visible-light image 120a under the control of the control signals in step S5.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An X-ray machine comprising:
a controllable X-ray generator being a cold cathode field emission device comprising a plurality of coupling anodes and cathodes, wherein each of the cathodes and anodes can be controlled individually to adjust X-ray emitting range, and a maximum irradiation range exists when all of the anodes emit X-rays;
a digital camera arranged correspondingly to the controllable X-ray generator to obtain an unvarying image shooting area which is the same as the maximum irradiation range;
a control unit operatively connected to the X-ray generator and the digital camera;
wherein the control unit can be configured to select a narrowed image portion within a digital visible-light image shot by and sent from the digital camera, and generates control signals including position data corresponding to the selected image portion within the digital visible-light image, the control signals are sent to the controllable X-ray generator, and the cathodes and/or the anodes of the X-ray generator are controlled by the control signals to drive the X-ray generator to irradiate an object portion corresponding to the selected image portion within the digital visible-light image.

2. The X-ray machine as in claim 1, wherein the control unit is operated manually to select the narrowed image portion.

3. The X-ray machine as in claim 1, wherein the control unit is operated automatically to select the narrowed image portion.

4. A method for controlling an X-ray machine to irradiate a narrowed portion within a maximum irradiation range, comprising
a) providing a controllable X-ray generator, wherein the controllable X-ray generator is a cold cathode field emission device comprising a plurality of coupling anodes and cathodes, each of the cathodes and anodes can be controlled individually to adjust X-ray emitting range, and a maximum irradiation range exists when all of the anodes emit X-rays;
b) generating a digital visible-light image with a shooting area the same as the maximum irradiation range;
c) selecting a narrowed image portion within the digital visible-light image;
d) generating control signals including position data corresponding to the selected image portion within the digital visible-light image;
e) driving the controllable X-ray generator to emit X-rays to an object portion within the maximum irradiation range under a control of the control signals to the cathodes and/or anodes, wherein the object portion is corresponding to the selected portion within the digital visible-light image.

5. The method as in claim 4, wherein the digital visible-light image in step b is generated by a digital camera.

6. The method as in claim 4, wherein the step c is manually operated.

7. The method as in claim 4, wherein the step c is automatically operated.

8. An X-ray machine comprising:
a controllable X-ray generator without any baffle plate barrier in front for blocking X-rays;
a digital camera arranged correspondingly to the controllable X-ray generator to obtain an unvarying image shooting area which is the same as a maximum irradiation range of the controllable X-ray generator;
a control unit operatively connected to the X-ray generator and the digital camera;
wherein the control unit can be configured to select a narrowed image portion within a digital visible-light image sent from the digital camera and generates control signals including position data corresponding to the selected image portion, the control signals are sent to the controllable X-ray generator, and the X-ray generator is controlled by the control signals to irradiate an object portion corresponding to the selected image portion within the digital visible-light image.

9. The X-ray machine as in claim 8, wherein the controllable X-ray generator is a cold cathode field emission device comprising a plurality of coupling anodes and cathodes, each of the cathodes and anodes can be controlled individually to adjust X-ray emitting range, and the cathodes and/or anodes of the X-ray generator are controlled by the control signals to drive the X-ray generator to irradiate.
